(19) United States
(12) Patent Application Publication
(10) Pub. No.: US 2026/0060173 A1
(43) Pub. Date: Mar. 5, 2026

(54) SYSTEM AND METHOD FOR CONTROLLING OPERATION OF A WORK MACHINE BASED ON PLANT PART INTERIOR CHARACTERISTICS

(71) Applicant: Deere & Company, Moline, IL (US)

(72) Inventors: Mahesh Somarowthu, Pune (IN); Noel W. Anderson, Fargo, ND (US); Timothy A. Wilcox, Cissna, IL (US)

(21) Appl. No.: 18/819,086

(22) Filed: Aug. 29, 2024

(51) Int. Cl. A01D 41/127; G01N 21/3586; G06T 7/00; G06V 20/10; G06V 20/56

(52) U.S. Cl. CPC A01D 41/127; G01N 21/3586; G06T 7/0012; G06V 20/188; G06V 20/56; G01N 2201/0216; G06T 2207/20081; G06T 2207/30188; G06T 2207/30252

(57) ABSTRACT

Interior plant part sensing and classification are provided for work machine, e.g., agricultural machine, control. First input signals (e.g., camera images) correspond to a field of view including plant parts in a traversed work area, wherein exterior attributes of plant parts are identified based on the received first input signals. Second input signals correspond to penetrating (e.g., non-ionizing) radiation directed toward the plant parts, wherein at least one interior plant part attribute is determined with respect to the plant parts, based on the received second input signals. Exemplary attributes may corresponding to identified interior silhouettes, layers, boundaries, voids, shapes, and the like. Action signals are generated corresponding to an operation in the work area, based on at least the determined at least one interior plant part attribute. Actions signals may be generated for display, crop care control, harvest machine control, harvest logistics control, and the like.

### FIELD OF THE DISCLOSURE

The present disclosure relates generally to work machines having associated work implements, for example towed by or otherwise associated with self-propelled work vehicles, and more particularly to a method and system for controlling or otherwise generating action signals with respect to operation of such work implements based on detected and/or estimated plant part interior characteristics within a work area being traversed by the work machine.

### BACKGROUND

A work area may for example represent a field for growing a crop or other vegetation, or another type of area including terrain to be worked by an implement or other tool associated with a work machine.

Exterior plant attributes (also referred to herein as exterior characteristics) have been used in some conventional systems and methods to control agricultural machines and provide data for guiding subsequent agricultural practices. Without limitation, examples include normalized difference vegetation index (NDVI) for nitrogen applications, biomass (e.g., height x population, leaf area index) for harvester feed rate control, stalk diameter for deck plate gap adjustments, and the like.

Interior plant attributes, or interior characteristics, particularly those related to seeds or pests obscured by husks (e.g., corn ears), pods (e.g., soybeans), heads (e.g., small grains), and shells (e.g., nuts), or those related to fleshy bodies under skins such as fruit (e.g., apples, grapes), or tubers (e.g., potatoes) have not been widely used for self-propelled or otherwise mobile agricultural machine control.

X-rays, gamma rays, positron emission tomography (PET), and magnetic resonance imaging (MRI) sensors have each been used in conventional systems and methods for laboratory and food processing factory sensing of plant part interiors. These technologies can be highly effective in the right context, but do not easily transfer to agricultural field environments because of the requisite sensor size, cost, and regulation (e.g., x-rays and gamma rays are highly regulated due to ionizing radiation and radioactive sources). Nor have sensed interior attributes been actionable in conventional applications, whether for real-time control or logistics for current or subsequent seasons, at least because of the lack of in situ detection/estimation and/or georeferencing of the interior attributes for individual or collective groups of plant parts.

### BRIEF SUMMARY

Various embodiments of systems and/or methods as disclosed herein are provided to address some or all of the problems referenced above with respect to interior plant part sensing and corresponding utilization for mobile agricultural machine control, at least in part by using penetrating (e.g., non-ionizing) signals which can be generated and received with affordable, machine mountable components and processed to generate action signals for display, for crop care control, for harvest machine control, for harvest logistics control, and the like.

In one particular and exemplary embodiment, a computer-implemented method as disclosed herein may comprise: receiving one or more first input signals corresponding to a field of view comprising one or more plant parts in a work area being traversed by a work machine, wherein the field of view is associated with one or more exterior attribute sensors associated with the work machine; identifying an exterior attribute (e.g., contour) of at least one of the one or more plant parts based on the received one or more first input signals; receiving one or more second input signals corresponding to penetrating radiation directed toward the at least one of the one or more plant parts, wherein the penetrating radiation is received by one or more interior attribute sensors associated with the work machine; determining at least one interior plant part attribute with respect to at least one of the one or more plant parts, based on at least the received one or more second input signals; and generating action signals corresponding to an operation in the work area, based on at least the determined at least one interior plant part attribute.

In one exemplary aspect according to the above-referenced embodiment, at least one of the one or more exterior attribute sensors and at least one of the interior attribute sensors may be same device. As one example, backscatter might be used to identify the soybean seed and then transmitted radiation provide information about the seed interior. In another example, a first received signal could be from the seed exterior, identifying the seed, and then a later reflected signal determined by internal characteristics.

In another exemplary aspect according to the above-referenced embodiment, the method may comprise training one or more first models over time to correlate identified exterior attributes based on the first input signals with respective types of plant parts, and training one or more second models over time to correlate characteristics of the penetrating radiation associated with the respective types of plant parts with interior plant part attributes of the respective types of plant parts. For a current set of one or more first input signals and a corresponding set of one or more second input signals, the at least one interior plant part attribute may be determined with respect to the at least one of the one or more plant parts by reference to a selected one of the one or more trained first models to identify a first type of plant part and by reference to a selected one of the one or more trained second models to determine the at least one interior plant part attribute.

In another exemplary aspect according to the above-referenced embodiment, the action signals may be generated based on a determined aggregate of interior plant part attributes with respect to a defined period of time and/or with respect to a defined distance traversed by the work machine and/or with respect to the work area being traversed.

In another exemplary aspect according to the above-referenced embodiment, the one or more first sensors and the one or more second sensors may be mounted on a first work machine, and the action signals may be generated corresponding to the operation by a second work machine in the work area.

In another exemplary aspect according to the above-referenced embodiment, the action signals generated by the first work machine may be utilized for mapping the determined at least one interior plant part attribute to a location of the respective plant part in a selectively retrievable data structure, for each of the one or more plant parts having an interior plant part attribute determined therefor.

In another exemplary aspect according to the above-referenced embodiment, the operation by the second work machine may be controlled based on the mapped attributes in the selectively retrievable data structure.

In another exemplary aspect according to the above-referenced embodiment, the operation may be performed in the work area by the work machine, and controlled based on the generated action signals.

In another exemplary aspect according to the above-referenced embodiment, the penetrating radiation may comprise non-ionizing radiation generated from at least one emitter associated with the work machine.

In another exemplary aspect according to the above-referenced embodiment, each of the one or more plant types within the field of view may be classified as one of a plurality of different plant types based at least in part on the respectively identified exterior contours, and the at least one interior plant part attribute may be determined with respect to plant parts classified according to a selected plant type.

In another embodiment as disclosed herein, a system comprises one or more first sensors associated with a work machine and configured to generate one or more first input signals corresponding to a field of view of the one or more sensors and comprising one or more plant parts in a work area being traversed by the work machine, and one or more second sensors associated with the work machine and configured to generate one or more second input signals corresponding to penetrating radiation directed toward the at least one of the one or more plant parts and received by the one or more second sensors. One or more processors are communicatively linked to the one or more first sensors and to the one or more second sensors to receive the respective input signals there from, and configured to direct the performance of steps in a method according to the above-referenced embodiment and optionally one or more of the exemplary aspects thereof.

In an exemplary aspect according to the above-referenced system embodiment, the one or more second sensors comprise at least one paired emitter and detector mounted on at least one side of the work machine and configured for reflection and backscatter measurements with respect to the emitted penetrating radiation.

In another exemplary aspect according to the above-referenced system embodiment, the one or more second sensors comprise at least one paired emitter and detector arranged such that plant parts pass between the respective emitter and detector pairing for attenuation measurements with respect to the emitted penetrating radiation.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view representing an exemplary work machine according to an embodiment of the present disclosure.

FIG. 2 is a perspective view representing another exemplary work machine according to an embodiment of the present disclosure.

FIG. 3 is an overhead view representing another exemplary work machine according to an embodiment of the present disclosure.

FIG. 4 is a block diagram representing an embodiment of a control system according to an embodiment of the present disclosure.

FIG. 5 is a flowchart representing an exemplary method according to an embodiment of the present disclosure.

### DETAILED DESCRIPTION

With reference herein to the representative figures, various embodiments may now be described of an inventive system 100 and/or method 300. Systems 100 and methods 300 as disclosed herein may generally relate to the use of penetrating electromagnetic radiation for collecting and classifying information regarding interior attributes of plant parts in a work area, for example an agricultural field being traversed by a work machine, and performing actions responsive to some or all of the classified interior attributes for some or all of the plant parts in at least a region of the work area. In situ collection and classification of penetrating radiation characteristics may enable actions such as real-time decision support and/or control of work operations in the field, logistics regarding subsequent work operations or varietal planning operations for subsequent seasons, etc.

While embodiments of such a system 100 and/or method 300 may be described as being performed with respect to a work machine 102 comprising a stationary device, a work implement being towed by a work vehicle, a work vehicle towing a work implement, a work vehicle having a front-mounted work implement, and/or a work vehicle having a work implement integrated therewith, etc., it may be appreciated that various steps of a method 300 as disclosed herein may be performed by systems 100 comprising individual ones of such machines 102, wherein for example a first machine performs one or more steps of a method as disclosed herein and a second machine performs some or all of the other steps in a method as disclosed herein. In some embodiments, a system 100 as disclosed herein may include a single work machine 102, or multiple work machines 102 in functional communication with each other, in communication with one or more remote computing devices (e.g., a cloud computing network or platform) to perform a method 300 as disclosed herein.

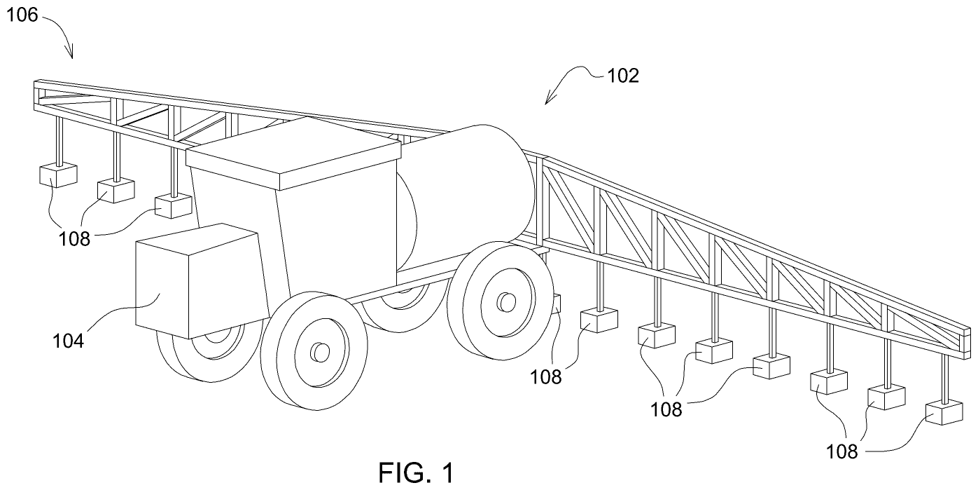

FIG. 1 illustrates one example of a work machine 102, in the form of a sprayer or spraying machine that hosts or otherwise embodies a system 100 as disclosed herein. A work vehicle 104 such as a sprayer vehicle may comprise a tank or tows a trailer with a tank thereon, where the tank contains crop inputs for spraying or application to plants, soil, or the field. The work vehicle 104 supports a boom assembly 106 which in the illustrated example comprises a lower boom member and an upper boom member that are connected via boom braces. The boom assembly 106 may conventionally support one or more nozzle assemblies 108 or nozzle heads per row unit. For example, a primary nozzle assembly 108a (not shown) may be supported by the boom assembly 106 to treat or spray a first row and a second row of crop, whereas a secondary nozzle assembly 108b (not shown) may be supported by the boom assembly 106 to treat or spray a second row of crop and a third row of crop, where a controller 202 (not shown in FIG. 1) may for example control, separately and independently, or in synchronization or coordination, the primary nozzle assembly 108a and the secondary nozzle assembly 108b for the targeted application of crop inputs and coverage of the crop inputs.

One or more sensors 214, 216 as further described below may be mounted upon, or as a drop down from the boom assembly 106, for example in association with one or more of the nozzle assemblies 108. One or more such sensors 214, 216 may further or alternatively be mounted on the work vehicle 104 portion of the work machine 102.

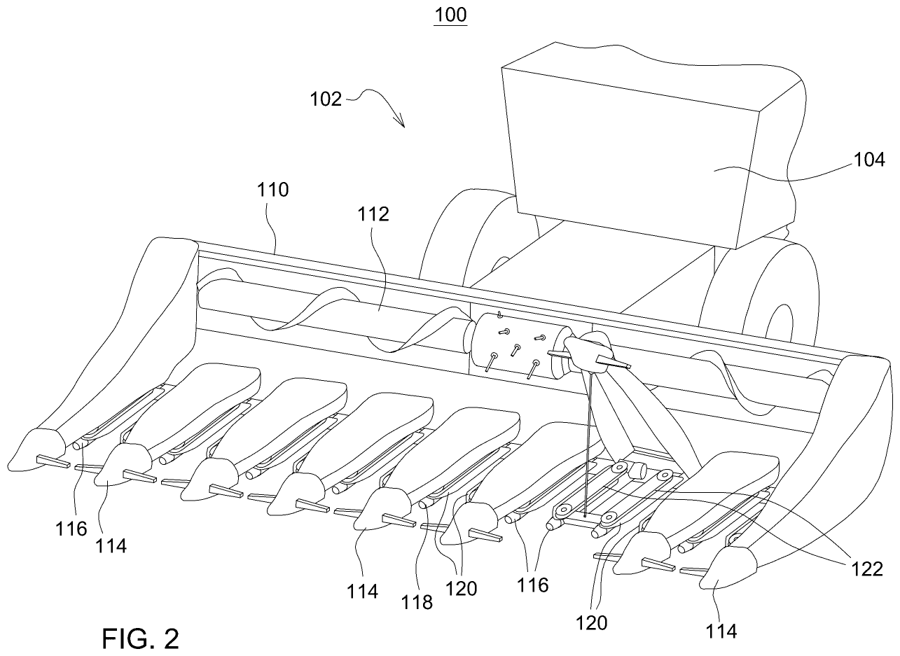

FIG. 2 illustrates an agricultural harvesting work machine 102 as another example of a work machine 102 that may host or otherwise embody a system 100 as disclosed herein. The following discussion relates to an embodiment of such a work machine 102 for harvesting corn but is not intended as limiting in any way. The illustrated agricultural harvesting work machine 102 comprises a work vehicle 104, in this example a combine harvester having a feeder house extending forward therefrom, and a row crop harvesting header 110 (here shown as a corn head) supported on a forward end of the feeder house. The agricultural harvesting work machine 102 (e.g., combine) harvests plants, each comprising a stalk or stem and at least one ear.

As the agricultural harvesting work machine 102 travels through the field harvesting rows of crop, individual crop plants in each row of crop pass between adjacent crop dividers 114, then further rearward into a row unit 118. The row unit 118 may include two spaced apart stalk rolls 116 that extend in a forward direction and define a gap therebetween for receiving stalks of the crop plants. As each crop plant is received into the gap, the stalk rolls 116 engage opposite sides of the stalk of the crop plant and pull the stalks downward.

Stripping plates 120 are disposed above the stalk rolls and on either side of the gap. As the stalk rolls pull the stalk of the crop plant downward, ears of corn extending from the stalk of the crop plant impact the stripping plates 120, causing the ears to be broken off the stalk.

These ears tumble and bounce upon the stripping plates 120, and are carried rearward by gathering chains 122 into a laterally extending trough in the header 110 (e.g. corn head). A transverse rotating auger 112 is disposed in the laterally extending trough. The transverse rotating auger 112 has protruding members (e.g., flights) that engage the broken-off ears of corn and carry them to a central region of the row crop harvesting header 110.

Once in the central region, protruding members (e.g., flights) on the transverse rotating auger 112 carry the ears of corn rearward and into the feeder house of the work machine 102.

A conveyor (not shown, e.g., rotating conveyer belt or endless flexible conveyer belt) in the feeder house may be provided to carry the ears of corn rearward and into the body of the work machine 102. Once inside the body of the work machine 102, the ears of corn are threshed by at least one threshing drum, and separated from the material other than grain (MOG). The kernels or seeds of grain are cleaned in a cleaning device (e.g., cleaning shoe), wherein the now-clean kernels or seeds of grain are carried upward by a grain elevator and are deposited in a grain tank.

In an embodiment, one or more sensors 214, 216 as further described below may be mounted upon a forward end of a crop divider 114 on the row crop harvesting header 110, for example with either an emitter/detector on one side for reflection and backscatter measurements, or with plants passing between an emitter and a detector on adjacent positions and extending outwardly from each opposing side for attenuation measurements.

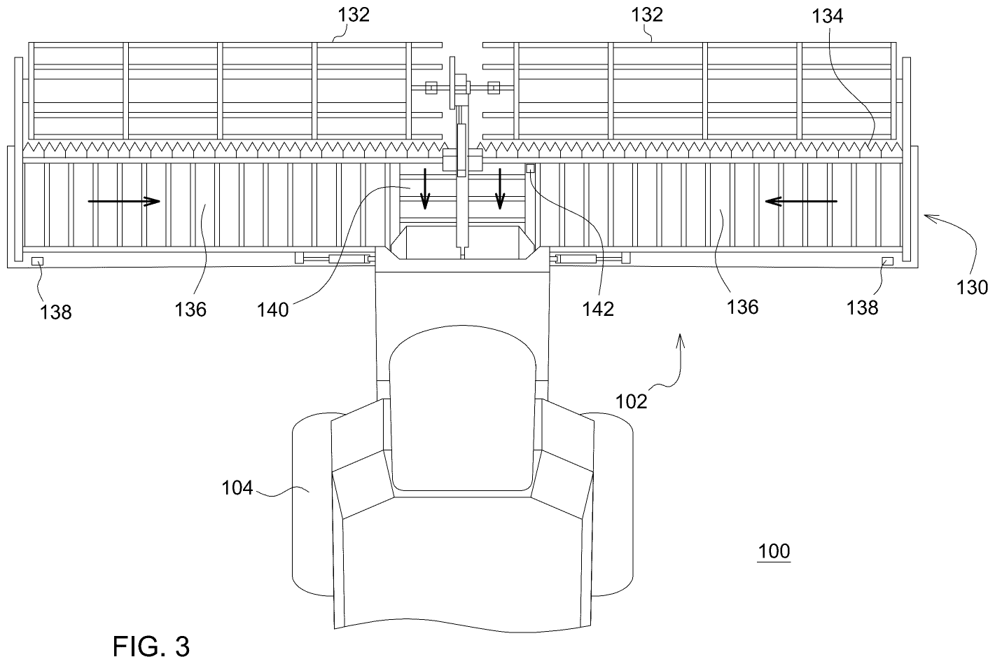

FIG. 3 illustrates another embodiment of an agricultural harvesting work machine 102 as another example of a work machine 102 that may host or otherwise embody a system 100 as disclosed herein. In the illustrative embodiment, the work machine 102 includes a header 130 coupled to the chassis and positioned to remove crop material such as grain from the ground. The header 130 includes a reel 132 to draw crop material into the header 130 so that the crop material may be conveyed rearwardly, and a cutter bar 134, and is removably coupled to a feeder house near a front end thereof.

The header 130 illustratively includes two outer belt conveyors 136 each connected to a drive 138 which drives them (e.g., in a harvesting mode) such that their top sides move inwardly (i.e., as shown by the arrows). As a result, the outer belt conveyors 136 convey harvested crop material captured by the reel 132 and severed by the cutter bar 134 to the center of the header 130. Crop material conveyed to the center of the header 130 is then conveyed by a central belt conveyor 140 that is driven by a drive 142 and transported rearwardly into the feeder house.

In an illustrative embodiment wherein the work machine 102 is a small grain header, one or more sensors 214, 216 as further described below may for example be mounted upon a rear side thereof for reflection and backscatter measurements of forward-emitted signals, or in the header 130 with signals transverse to a direction of travel as with row crops.

In various other alternatives, one or more sensors 214, 216 may be mounted on a handheld or otherwise portable device for use by human operators such as crop scouts, mounted on a crewed or uncrewed scouting vehicle separate from additional agricultural or other work functions, or other equivalent machines and devices as may appreciated by one of skill in the art. It may further be understood that sensors 214, 216 may be positioned on different locations of a work machine 102 based on the desired function, and the type of work performed, field conditions, etc.

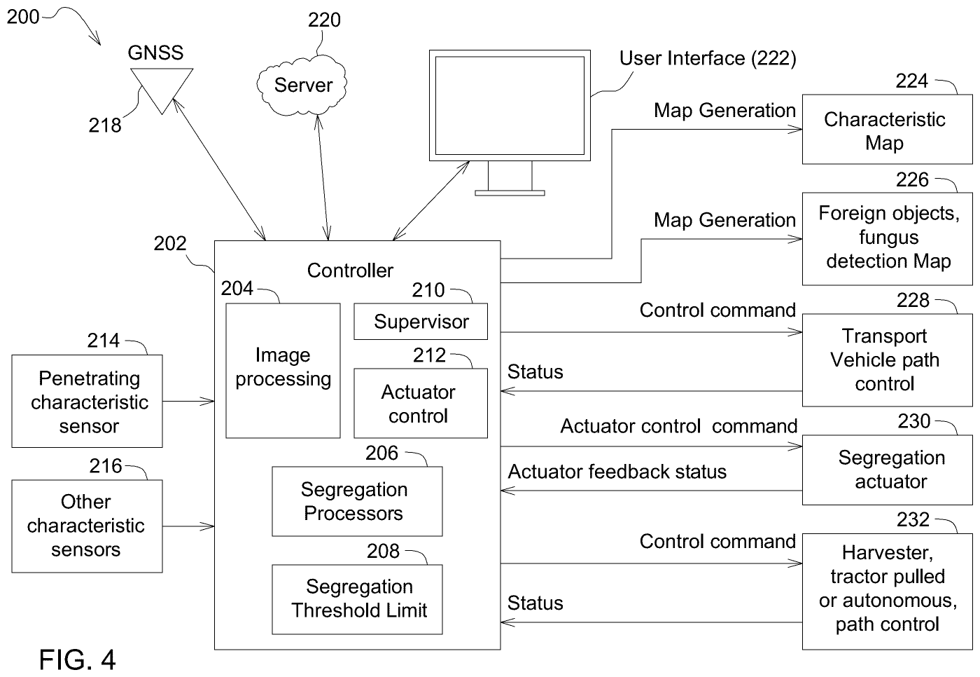

Referring next to FIG. 4, an embodiment of a control system 200 as disclosed herein may include one or more controllers 202 functionally linked to numerous sensors, actuators, displays, external computing devices, each other, and the like. A controller 202 as illustrated in FIG. 4 may be part of a machine control system of the work machine 102, or it may be a separate control module. It is understood that the controller 202 described herein may be a single controller having all of the described functionality, or it may include multiple controllers wherein the described functionality is distributed among the multiple controllers.

The controller 202 in the present embodiment is configured to receive input signals from some or all of penetrating characteristic sensors 214 and other characteristic sensors 216, as well as a position sensor 218 which can include, but is not limited to, a global navigation satellite system (GNSS) receiver that receives signals from a GNSS satellite transmitter. Penetrating characteristic sensors 214 may generally provide signals representative of emitted and received electromagnetic radiation using at least one wavelength capable of penetrating a visually obscuring exterior (outer surface) of a plant part. The other (non-penetrating) sensors 216 may be used as further described herein to determine exterior characteristics of a plant part (i.e., relating to attributes of the plant part that are not visually obscured by the outer surface), but in some embodiments may be used to supplement signals from penetrating sensors 214 and confirm or otherwise enhance the sensory capabilities with respect to estimating interior characteristics of the plant part.

The position sensor 218 can also for example include a Real-Time Kinematic (RTK) component that is configured to enhance the precision of position data derived from a GNSS signal. Illustratively, an RTK component uses measurements of the phase of the signal's carrier wave in addition to the information content of the signal to provide real-time corrections, which can provide up to centimeter-level accuracy of the position determination.

Various of the sensors 214, 216 may typically be discrete in nature, but signals representative of more than one input parameter may be provided from the same sensor, and one or more sensors as disclosed herein may further include or otherwise refer to signals provided from the machine control system. As used herein, a sensor signal may include both analog signals and digital signals, such as communications using a controller area network (CAN) bus.

In various embodiments, exemplary penetrating characteristic sensors 214 may generally include microwave, terahertz, x-ray, gamma-ray, magnetic, or other types of sensors configured to generate outputs representative of internal characteristics of a plant part, as determined from emitted and reflected energy.

In an exemplary embodiment relating to terahertz implementation, a terahertz-based sensor as penetrating characteristic sensor 214 may include a terahertz source disposed to direct terahertz electromagnetic radiation through a detection area to one or more terahertz detectors. In some examples, sensor 214 may only detect attenuation of terahertz electromagnetic radiation after passing through a plant part area, in which case a single detector may be used and positioned to receive the attenuated terahertz electromagnetic radiation. In other embodiments, sensor 214 may only detect reflection of the terahertz electromagnetic radiation from a plant part within the detection area, in which case a single detector may be used and positioned to receive the reflected terahertz electromagnetic radiation. Of course, embodiments within the scope of the present disclosure may also include using both such detectors to detect attenuated terahertz electromagnetic radiation as well as reflected electromagnetic radiation. Further, those skilled in the art will appreciate that additional/alternate terahertz detectors can be used to detect other types of interactions, such as backscatter. The terahertz source and terahertz detectors may be configured to use a single frequency or in other examples, a plurality of frequencies.

A Terahertz sensor configured to generate and detect electromagnetic radiation with a frequency between 0.1 terahertz and 30 terahertz, defined herein as terahertz electromagnetic radiation (spectroscopy), is subject to significant laboratory research and shows promise for agricultural applications. Terahertz electromagnetic radiation lies between microwave and infrared on the electromagnetic spectrum and provides the advantage of at least partial penetration into objects, but is not considered ionizing radiation, like x-rays. As such, terahertz radiation does not trigger a requirement for a safety officer, nor is it subject to significant regulations, such as those that apply to x-rays. However, terahertz electromagnetic radiation does provide improved detection abilities over optical techniques, such as for example infrared (IR) and ultraviolet (UV). In accordance with embodiments described herein, terahertz electromagnetic radiation may be employed relative to plant treatment operations, plant harvesting operations, and the like to detect and preferably segregate undesirable plant parts from desirable plant parts, in contexts as further described below.

An exemplary terahertz source can be any suitable device capable of providing terahertz electromagnetic radiation to a plant part detection area. Examples of such suitable devices may include, without limitation, a femtosecond Ti-sapphire laser, an Yttrium Iron Garnet (YIG)-oscillator, a quantum cascade laser, a P-type germanium laser, a silicon-based laser; a free electron laser, a photoconductive switch, optical rectification, a backward-wave oscillator, a transferred electron device (i.e., Gunn diode), and a resonant tunneling diode. In embodiments where a number of frequencies within the contemplated terahertz range (0.1-30 terahertz) are desired, a variable frequency source can be used, such as a variable frequency quantum cascade laser. In other embodiments, a plurality of sources can be used with each source having a different band within the terahertz range. Additionally, it is expressly contemplated that the source may operate in a pulsed mode or a continuous wave mode.

An exemplary detector can be any suitable device that can detect electromagnetic radiation in the terahertz range and may further provide measurements in the frequency domain or the time domain. Examples of detectors may include, without limitation, a photoconductive semiconductor, free-space electro-optic sampling using ZnTe and BBO crystals, bolometer, an interferometer, Schottky diode, backward diode, High-Electron-Mobility-Transistor (HEMT), Golay cell, and a pyroelectric detector.

A terahertz sensor as the penetrating characteristic sensor 214 (or one of multiple such sensors 214) may provide a signal that contains significant information about the material that the terahertz electromagnetic radiation has passed through and/or reflected from. The detector(s) may be operably coupled to the controller 202 and/or other processing elements in the system 100, which may for example include or be coupled to an artificial intelligence (AI) engine or the like.

Utilizing an AI engine may allow the system to perform relatively high level classifications based on the received signal(s). An exemplary such engine may employ any suitable artificial intelligence and/or machine learning techniques in the provision of such classification. Examples of suitable artificial intelligence techniques include, without limitation, memory networks, Bayes systems, decisions trees, Eigenvectors, Eigenvalues and Machine Learning, Evolutionary and Genetic Algorithms, Expert Systems/Rules, Support Vector Machines, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Cluster Analysis, Random Forests, Reinforcement Learning or Reward-based machine learning. Learning may be supervised or unsupervised. In other examples, signals may be processed using more traditional approaches such as measuring time-of-flight or phase information related to reflections at various plant part boundaries such as those between corn husk, kernels, and cob or between soybean pod and seed. In some examples, the returned signals may be affected by voids, material density changes, or constituent density changes within a plant part due to genetics, growing conditions, pests, disease, etc. Other traditional processing approaches include computer vision techniques to process signals received by a matrix of detectors comprising an image of a portion of a plant.

In various embodiments, a single sensor 214 or multiple such sensors can be used along a path of travel for the work machine, for each example in association with each of a number of row units.

In various embodiments, exemplary other characteristic sensors 216 may generally utilize non-penetrating electromagnetic energy (e.g., associated with radio frequency, infrared, visible, ultraviolet light, etc.), ultrasound detection, volume/shape detection (e.g., via stereo camera, structured light, etc.), or mass detection (e.g., via load cells, impact sensing, etc.).

In a particular example, an imaging device as a characteristic sensor 216 may be configured to obtain or to collect image data associated with one or more target plants in one or more rows of the standing crop in a work area (e.g., field). The controller 202 or other equivalent processor may estimate a spatial region of plant pixels of one or more target plants in the obtained image data for a harvestable plant part and its associated pixels of the harvestable plant part. For example, the harvestable plant component may comprise a grain bearing portion (GBP) of a plant, an ear, a grain head for a grain, corn, maize, wheat, rye, oats, rice, sorghum, cereal or quasi-cereal plant.

The controller may further identify the component pixels of a harvestable plant part within the obtained image data of plant pixels of the one or more target plants. For example, the component pixels refer to pixels of the harvestable plant component that are identified or classified by color differentiation or other image processing techniques with respect to background pixels, leaf pixels, stem or stalk pixels, or other portions of the crop plant. Other image processing techniques may include classification of pixels by any of the following: image segmentation, clustering analysis of point clouds of pixels or constellations of pixels in three dimensional spatial representation, edge detection, size differentiation, and shape differentiation, and neural networks or artificial intelligence algorithms that use any of the foregoing image processing techniques.

The controller 202 may be configured to determine an edge, boundary, or outline of the component pixels of the harvestable plant part. An image normalizer or image scaler may be utilized to normalize and scale the collected images to imaging device coordinates or real world coordinates. The controller, or an imaging processing module in association therewith, may normalize, scale, rotate, de-warp, correct, and/or transform the collected images to imaging device coordinates or real world coordinates. The controller, or an imaging processing module in association therewith, may further apply edge detection, such as linear edge detector or Hough transform, to the normalized, scaled, rotated, de-warped, corrected, and/or transformed images to detect the transition region and boundary of the component pixels of the harvestable plant parts associated with one or more crop plants in the field.

The controller 202, or an imaging processing module in association therewith, may further be configured to detect or estimate a size of the harvestable plant part based on the determined edge, boundary or outline of the identified component pixels. For example, after the collected images are normalized and scaled to imaging device coordinates or real world coordinates, the controller may estimate the size or volume of the harvestable plant part along one or more orthogonal axes or in polar coordinates.

In one embodiment, the controller 202 may be configured to determine the estimated or detected size of the harvestable plant part (e.g., grain bearing portion or ear of a crop plant), and optionally to provide the size on a user interface 222 (e.g., an electronic display). The detected size may comprise any of the following: length, width and height of a harvestable plant part, a volume of a harvestable plant part, a length (e.g., along an ear longitudinal axis) and diameter or radius (e.g., ear radius substantially perpendicular to the ear longitudinal axis) of a harvestable plant part, an outline, silhouette or shape of the harvestable plant part, a count of seeds (e.g., kernels) of the harvestable plant part, a grain size of a harvestable plant part, or other metrics.

In various embodiments, a harvestable plant part as determinable using sensor 216 may comprise one or more of the following: a grain bearing portion of the one or more target plants, an ear of corn or maize of the one or more target plants, a pod of legumes, a fiber bearing portion, a cotton boll, and the like, including portions thereof.

The controller 202 may for example be configured to distinguish component pixels from background pixels, by color differentiation, edge detection, and shape detection obtained image data. Further, the background pixels may comprise weed pixels or ground pixels of weeds or grounds around the one or more target plants, where the image data is structured as multi-dimensional constellation or cloud of points for the edge detection and shape detection.

In alternate embodiments where a imaging device as sensor 216 comprises a stereo imaging device or where three-dimensional clouds of plant and background pixels are available, the controller 202 (or other associated processors) may for example be capable of identifying additional background pixels, such as plant pixels from adjacent crop plants, as opposed to weeds, where such plant pixels comprise of pixels that represent crop leaves, stalk, or ears from an adjacent or next plant in a row or adjoining row. In some examples, all or a portion of the information described as coming from data received from other characteristic sensors 216 may be derived from data received from penetrating characteristic sensors 214.

The controller 202 may for example be configured to identify the component pixels by distinguishing component pixels from background pixels by classification of obtained image data via an artificial intelligence data processing algorithm, where the image data is structured as a three-dimensional constellation or cloud of points, and where the artificial intelligence data processing algorithm is or was trained with a reference image data comprising three-dimensional constellation or cloud of points.

The controller 202 may in some embodiments further receive inputs from and generate outputs to remote user devices associated with a user via a respective user interface 222, for example a display unit with touchscreen interface and associated input/output devices and functionality. Data transmission, between for example a vehicle control system 200 and a remote user interface 222, may take the form of a wireless communications system and associated components as are conventionally known in the art. In certain embodiments, a remote user interface 222 and vehicle control systems 200 for respective work machines 102 may be further coordinated or otherwise interact with a remote server 220 or other computing device for the performance of operations in a system 100 as disclosed herein.

In various embodiments, the controller 202 may comprise or otherwise be functionally linked to one or more processors 204 configured for image processing, one or more processors 206 configured for segregation of crop elements or the like, and data storage 208 comprising segregation threshold limits as determined for example by any of the one or more processors 204, 206 or from input via the user interface 222.

The controller 202 may further comprise or otherwise be linked to processors and/or data storage enabling supervisory decision support and/or automation functions 210 and the generation of control signals 212 for controlling the operation of respective actuators. For example, the controller 202 may generate output signals for map generation, for example at the controller or remote server level, with respect to a plan part characteristic map 224, a plant part foreign objects map 226 (e.g., fungus detection), and the like. The controller 202 may generate signals for indirect control of relevant actuators via intermediate control units, associated with for example a work vehicle path control system 228, a work machine plant part segregation control system 230, a work machine (e.g., tractor pulled or autonomous harvester) path control system 232, etc. Such control systems may be independent or otherwise integrated together or as part of a machine control unit in various manners as known in the art.

Various “computer-implemented” operations, steps or algorithms as described in connection with the controller 202 or alternative but equivalent computing devices or systems can be embodied directly in hardware, in a computer program product such as a software module executed by processors 204, 206, or in a combination thereof. The computer program product can reside in RAM memory, flash memory, ROM memory, EPROM memory, EEPROM memory, registers, hard disk, a removable disk, or any other form of computer-readable medium known in the art. An exemplary computer-readable medium can be integral with or otherwise coupled to processors 204, 206 such that the processors 204, 206 can read information from, and write information to, the memory/storage medium.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a digital signal processor (DSP) and a microprocessor, a plurality of microprocessors, one or more microprocessors in conjunction with a DSP core, or any other such configuration.

As noted above, various operations as disclosed herein may be executed via a controller 202 for a given work machine 102, wherein the controller may be a discrete device or integrated with a vehicle control system or equivalent. In various embodiments as initially noted above operations may further or in the alternative be executed via a distributed system 100 including one or more remote processors, such as for example are associated with hosted servers in a cloud computing platform or mobile user devices, independently or in association with a local controller 202 for each of one or more work machines 102.

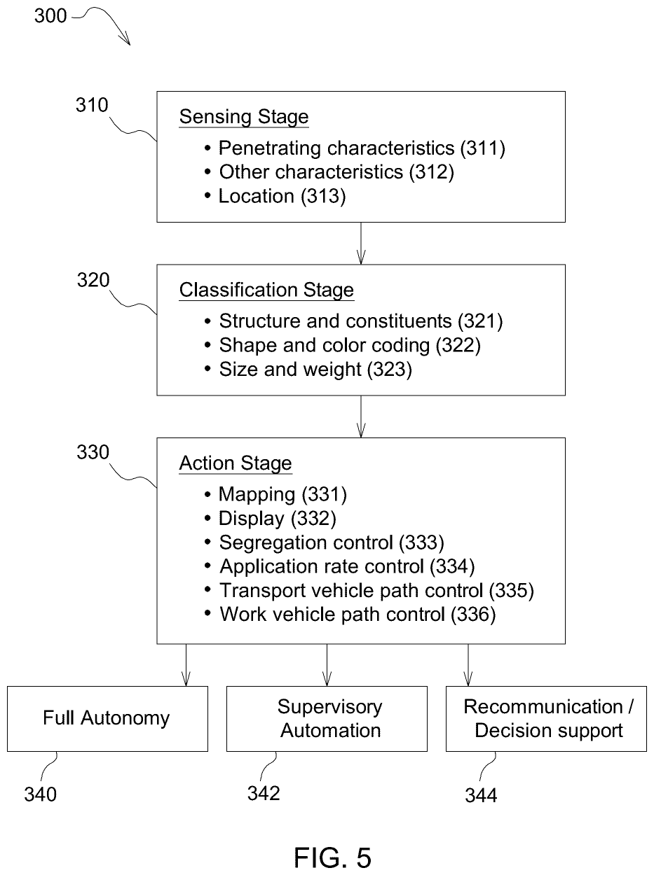

Referring next to FIG. 5, the depicted flowchart represents various exemplary embodiments of a method 300 for operating a work machine 102, primarily with respect to sensed and classified plant parts in a work area. While the illustrated embodiment may include a specific arrangement of steps, inputs, outputs, and the like, it may be understood that certain steps may be combined, performed in a different order, or even omitted altogether in other embodiments within the scope of the present disclosure, unless otherwise specifically noted herein. Whereas a method 300 as illustrated may represent general steps, more particular embodiments may be further described below, for example as relating to specific types of plants, operations, and/or work machines.

The illustrated embodiment of method 300 includes a sensing stage 310, which may comprise one or more of sensing and optionally storing values corresponding to penetrating interior characteristics 311 of radiation emitted to and reflected from plant parts, other characteristics 312 such as exterior attributes of plant parts, and respective locations 313 of the plant parts. The sensed values may for example be provided through the use of sensors 214, 216 and GNSS receiver 218 according to system 100 and control system 200. Examples of such characteristics 311, 312 may vary depending on the type of plant, operation, and/or work machine.

In an embodiment, the sensing stage 310 of method 300 may include characterizing a type of plant part present in a given work area or field of view of one or more non-penetrating sensors 216, and further selecting a group of values to be sensed for that particular type of plant part, for example using signals provided from either or each of the penetrating sensors 214 and/or non-penetrating (other) sensors 216.

For example, a first set of input signals may be received corresponding to a field of view including plant parts in a work area being traversed by a work machine, wherein the field of view is associated with a first set of sensors mounted upon or otherwise associated with the work machine. The controller (or a linked processor) can for example utilize image classification to identify an exterior contour of the plant parts, or at least certain specified types of plant parts, such that a second set of input signals corresponding to characteristics of penetrating radiation directed to or otherwise associated with the same field of view can be received and used to determine attributes of the identified plant parts. For example, upon identifying respective plant part contours as being associated with corn or soybeans, penetrating radiation associated with those same plant parts may be characterized accordingly, based on previously observed or otherwise specified relationships.

The input signals associated with exterior characteristics (e.g., contours) of the plant parts and interior attributes of those plant parts may typically be generated based on signals emitted from and received by different sensing devices. However, it may be contemplated that in some embodiments certain exterior characteristics are determinable using signals associated with penetrating radiation, or that certain interior characteristics and/or corresponding attributes are determinable using signals associated with non-penetrating radiation.

The illustrated embodiment of method 300 includes a classification stage 320, which may comprise, for a given plant part, classifying a structure and one or more constituents 321, shape and color coding 322, estimating a size and weight 323, or the like.

In an embodiment, various models may be generated and trained over time to classify plant parts and further determine corresponding attributes based on the penetrating radiation in combination with the identified type of plant part. Development and training of such models may for example be implemented using an artificial intelligence engine as noted above. For example, one or more models (i.e., “first” models) may be trained to correlate identified exterior contours (e.g., using the first set of input signals as noted above) with respective types of plant parts, and another set of one or more models (i.e., “second” models) may be trained to correlate characteristics of the penetrating radiation associated with the respective types of plant parts with interior plant part attributes of the respective types of plant parts. Once the models have been trained and preferably validated for at least some of the relevant types of plant parts and attributes, input signals may be collected and utilized for a current work operation (i.e., use of a work machine as disclosed herein in a work area including one or more plant parts) to determine at least one interior plant part attribute by reference to a selected and retrieved one of the “first” models to identify a first type of plant part and by reference to a selected and retrieved one of the “second” models to determine the at least one interior plant part attribute.

In an embodiment, model development may include variable governing parameters which are optimized during training to better simulate (or approximate in a particular simulation) observed real-life data corresponding to an input dataset. Such variables may comprise hyperparameters that may initially be set (e.g., user-specified) before training. Tuning of the hyperparameters, or in other words optimizing the values thereof, follows during training to obtain a set of values for the hyperparameters corresponding to an accurate input-output mapping of the model for the training dataset. In various embodiments, tuning of parameters may be performed automatically during or between training iterations, manually based on user selection via a system interface, or combinations thereof.

Exemplary interior characteristics within the scope of the present disclosure, dependent in part on the type of plant part at issue, may include thicknesses, depths, kernel structures such as a number of kernel rows and/or kernels in a given row, /ed/ seed part structures (e.g., embryo, endosperm, radicle, plumule, seed coat, etc.), size (e.g., volume, diameter), shape or density structures (e.g., corn ear, corn cob, soybean pod), voids (e.g., missing seeds, potato “hollow heart”), interior constituents (e.g., starch, protein, oil, toxins), interior foreign objects (e.g., fungi, diseases, pests).

The illustrated embodiment of method 300 includes an action stage 330, which may comprise one or more actions taken with respect to a given plant part and selected from mapping 331 of characteristics, foreign objects or the like, generating a display 332, segregation control 333, application rate control 334, transport vehicle path control 335, work vehicle path control 336, work implement path control, or the like.

In various embodiments, segregation control 333 may for example take the form of selectively diverting on-board material streams, haulage vehicle selection, haulage vehicle compartment selection, and the like, based on one or more respectively ascertainable interior plant part characteristics.

According to the illustrated embodiment of method 300, steps in the action stage 330 may be implemented via full autonomy 340, supervisory automation 342, operator feedback for decision support only 344, or the like.

Action signals may for example be based on a type of current operation, further optionally in view of a selected control mode. In various embodiments, action signals may be conditionally generated based on a determined aggregate of interior plant part attributes with respect to a defined period of time, a defined distance traversed by the work machine, a work area being traversed, and/or the like.

In an embodiment, sensors associated with a first work machine may be utilized to perform at least the above-referenced sensing stage, wherein the signals generated are utilized for mapping ascertained interior plant part attributes to respective locations in a selectively retrievable data structure. When a second work machine (or potentially the first work machine at a later time) performs an operation in the same work area, the operation may be controlled based on the mapped attributes in the selectively retrievable data structure.

In an embodiment, sensors associated with a first work machine may be utilized to perform at least the above-referenced sensing stage, wherein the signals generated are utilized for mapping ascertained interior plant part attributes to plant parts that are further harvested from the work area and stored in respective locations (e.g., identified bags, bins, etc.). When a second work machine (or potentially the first work machine at a later time) performs an operation (e.g., segregation of product having less desirable attributes from corresponding product having more desirable attributes) with respect to a selected bag or other storage area including plant parts, the operation may be controlled based on the mapped attributes, for example the known presence of at least some plant parts having less desirable attributes in a given storage area.

In one exemplary use case, a system and method as disclosed herein may be utilized to identify corn, sense interior characteristics of the corn, and perform actions in a work operation based on the interior characteristics, on a per-plant part basis or with respect to an aggregate of plant parts in a given area.

In such a use case, signals representative of the shape of a corn ear, such as for example a silhouette thereof, may be used to identify the presence of conditions to be remediated by the selective application of treatment such as pesticide (e.g., insects, fungus, etc.), or to identify non-pollinized and aborted kernels leading to reduced in-season fertilizer application, altered harvest logistics, or the like. Nitrogen use efficiency analysis may be scaled to account for non-nitrogen stress yield reductions.

In an embodiment, the silhouette of a corn ear may be determined using a transmitter/receiver pair through which the ear passes, with the signal being attenuated by moisture and/or plant matter. Defects related to unpollinated kernels, aborted kernels, etc., may be expected to show up with less attenuation and smaller dimensions than normal kernels.

Further according to such a use case, signals representative of a corn ear layer depth may be implemented, for example by estimating a difference between the start of the cob and the start of kernels under the husk, to estimate a kernel volume. Boundaries between husks/kernels and kernels/cob may for example create reflections and backscattering which can be interpreted as distances/depths. Values and/or metrics associated with the kernel volume can be used for actions such as in-season adjustments to fertilizer rate based on yield potential, or otherwise to plan or adjust harvest logistics. Estimated values and/or metrics for the sizes of corn ears, corn cobs, and the like (e.g., based on average, median, minimum, maximum values for plant parts in a batch) may further be used for optimizing work machine settings, such as for example combine settings, during a work operation.

Row and kernel count, and/or kernel size may also be utilized for yield estimation, wherein equivalent planning or real-time control functions may be executed. Values for kernel count and size may for example require three-dimensional data provided through the use of multiple views/fields of vision and signals that provide submillimeter resolution such as for spaces between kernels.

In an embodiment, during a sensing stage of the method, a sensor may be disposed on each row for sensing every ear of corn, ears of corn may be sampled from selected rows in the work area, ears of corn may be selected for sampling based on a detected orientation relative to the sensor, ears of corn may be selected for sampling based on image processing time, etc. Selected ears of corn may in some embodiments be diverted to a sensor, particularly where three-dimensional analysis may be desired. In some embodiments, raw data may be collected in the field and then post-processed to identify specific plant parts for further analysis or to estimate aggregate values for a group of plant parts, wherein real time control is unavailable, but the analysis may be utilized for downstream planning and/or control functions.

For example, during the growing season, as previously noted herein, yield estimations based on interior characteristics of individual or collective plant parts may be used for fertilizer application control or harvest logistics planning, or foreign object detection such as insects or fungus may be used for pesticide application control. Amounts of pesticide, or portions of a plant being sprayed, may be adjusted on a per-plant basis. Amounts of pesticide, or portions of a work area to be sprayed, may be adjusted on a per-region basis.

During a harvesting season, exemplary predictive yield harvest logistics may include estimated plant stress from poor pollination, kernel abortion, nutrient deficiency, water stress, etc.

Even beyond planning for treatment and/or harvest for a current growing season, estimated data from the sensed interior characteristics may be used to select and/or control varieties and planting rates for future growing seasons.

In another exemplary use case, a system and method as disclosed herein may be utilized to identify soybeans, sense interior characteristics of the soybeans, and perform actions in a work operation based on the interior characteristics, on a per-plant part basis or with respect to an aggregate of plant parts in a given area. Soybean pods are an essential factor in determining the yield and quality of the grain. Segmentation of pods may be enabled from pictures, wherein an effective calculation may be provided for one or more shape traits of the pod. However, non-penetrating sensors can only estimate a potential number and size of seeds in the pods, but cannot explicitly sense what is actually present.

Similarly with respect to the above use case for corn, the problem of measuring seeds in a soybean pod may be solved in a method according to the present disclosure using a penetrating sensor, and more particularly in various embodiments a terahertz sensor. In some examples, a visual or other wavelength image is used to provide an exterior (visually obtained) number of seed locations in a pod and combined with a terahertz image to provide the actual number of seeds and other attributes including, without limitation, size, moisture, etc. This data can be mapped and displayed to a user. The data may also be used to generate summary statistics for a region.

A constituent sensor can be adapted to measure and/or detect a variety of properties of the crop, further supplementing the above-referenced attributes for control (in real-time or in subsequent operations) or planning functions. Such properties may include, for example, moisture content, dry matter content, acid detergent fiber (ADF), neutral detergent fiber (NDF), lignin, metabolized energy, crude protein, and the like.

In the case of soybean development, there are known problems associated with the effects of drought, wherein supplemental measurement of other constituent properties which may correspond to such drought effects can potentially enhance the predictive aspects disclosed herein with respect to exterior and interior attributes, and associated control and/or planning functions. For example, predictive combine adjustments may be desirable to account for smaller seed sizes resulting from drought. Soybean plants that senesce before maturity due to stress may produce green seed that can result in dockage at the grain elevator, wherein the use of sensescence data may preferably be used to predict green seeds for quality metrics and segregation. Additional problems linked to drought conditions may include green stems at harvest, pod shattering, sprouted seeds, susceptibility to invasion by fungi, any one or more of which may prompt actions as disclosed herein for harvest logistics, for example relating to quality segregation, and/or for varietal selection and control for subsequent seasons.

The constituent sensor in some embodiments may include either or both of the penetrating and other (non-penetrating) sensors, for example utilizing the same functionality to provide or enable different sensing features. The terahertz sensor as one example of a penetrating sensor may be configured to generate and detect electromagnetic waves at terahertz frequencies, with the detected electromagnetic waves being converted to electronic signals that can provide information regarding the constituents of the crop, group the constituents by size and color, classify them, etc.

Spectroscopy of reflected terahertz signals may for example be used for such constituent sensing. Terahertz wavelengths may further be analyzed to sense absorption to determine mass, density, presence, etc.

Another exemplary constituent sensor may be a near-infrared-reflectance (NIR) sensor. Another example of a constituent sensor may include the HarvestLab™ 3000 sensor which continuously measures and monitors protein, starch and oil values in plant parts such as wheat, barley, or canola in real time.

As another use case, interior characteristic sensing and actions enabled by a system and method according to the present disclosure may be applied with respect to small grain heads.

As one example of an interior characteristic that can be sensed or estimated, users benefit greatly from the knowledge that insects such as stem borers or gall midges that are present in grain, and the ability to take action on that knowledge. The presence of pests may for example correspond to detected voids (e.g., circular tunnels), pest chemistry, etc.

Other examples of interior characteristics for small grain may be specific to the type of plant and/or the desired end use. For example, oats to be provided as feed for may have different specifications than oats used for milling, and different interior characteristics corresponding to the desired specifications. Kernel quality characteristics which may be of primary concern for the market of premium racehorse feed may include uniformly large kernels with bright, white hull color and very high test weight, in addition to high oil and protein content, whereas feed for other animals may have a greater emphasis on yield and therefore different predictive actions taken during associated work operations, varietal planning, etc.

As another use case, interior characteristic sensing and actions enabled by a system and method according to the present disclosure may be applied with respect to nuts such as almonds. Penetrating sensor signals and associated signal processing, data analysis techniques, etc., may enable the sensing of concealed damage such as pinholes, water-soaked spots, internal gumming, necrotic spots, and the like.

As another use case, interior characteristic sensing and actions enabled by a system and method according to the present disclosure may be applied with respect to fruit or vegetable plants and plant parts. Using the example of potatoes, penetrating sensor signals and associated signal processing, data analysis techniques, etc., may enable the sensing of internal cavities (e.g., “hollow heart”). Electromagnetic signals may be attenuated when traveling through the potato, wherein for potatoes having such internal voids the attenuation may be less than would be suggested by exterior characteristics (e.g., diameter). Void detection may accordingly be based on actual to expected attenuation ratio threshold, as determining using rules-based or modeled relationships over time.

In another use case, for example, sorted plant parts (e.g., potatoes) may be selectively collected in storage containers such as bags having georeferenced plant attribute data. The selection may for example be based on quality sorting criteria, sizing criteria, etc. Alternatively, interior characteristics of potatoes that have already been collected in storage containers may be analyzed for estimating or predicting quality metrics for the product in the aggregate.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method comprising:
receiving one or more first input signals corresponding to a field of view comprising one or more plant parts in a work area being traversed by a work machine, wherein the field of view is associated with one or more exterior attribute sensors associated with the work machine;
identifying an exterior attribute of at least one of the one or more plant parts based on the received one or more first input signals;
receiving one or more second input signals corresponding to penetrating radiation directed toward the at least one of the one or more plant parts, wherein the penetrating radiation is received by one or more interior attribute sensors associated with the work machine;
determining at least one interior plant part attribute with respect to at least one of the one or more plant parts, based on at least the received one or more second input signals; and
generating action signals corresponding to an operation in the work area, based on at least the determined at least one interior plant part attribute.

2. The computer-implemented method of claim 1, wherein at least one of the exterior attribute sensors and at least one of the one or more interior attribute sensors are the same device.

3. The computer-implemented method of claim 1, comprising:
training one or more first models over time to correlate identified exterior contours based on the first input signals with respective types of plant parts; and
training one or more second models over time to correlate characteristics of the penetrating radiation associated with the respective types of plant parts with interior plant part attributes of the respective types of plant parts;
wherein for a current set of one or more first input signals and a corresponding set of one or more second input signals the at least one interior plant part attribute is determined with respect to the at least one of the one or more plant parts by reference to a selected one of the one or more trained first models to identify a first type of plant part and by reference to a selected one of the one or more trained second models to determine the at least one interior plant part attribute.

4. The computer-implemented method of claim 1, comprising generating the action signals based on a determined aggregate of interior plant part attributes with respect to a defined period of time and/or with respect to a defined distance traversed by the work machine and/or with respect to the work area being traversed.

5. The computer-implemented method of claim 1, wherein the one or more exterior attribute sensors and the one or more interior attribute sensors are mounted on a first work machine, and the action signals are generated corresponding to the operation by a second work machine in the work area.

6. The computer-implemented method of claim 5, wherein the action signals generated by the first work machine are utilized for mapping the determined at least one interior plant part attribute to a location of the respective plant part in a selectively retrievable data structure, for each of the one or more plant parts having an interior plant part attribute determined therefor.

7. The computer-implemented method of claim 6, wherein the operation by the second work machine is controlled based on the mapped attributes in the selectively retrievable data structure.

8. The computer-implemented method of claim 1, wherein the operation is performed in the work area by the work machine, and controlled based on the generated action signals.

9. The computer-implemented method of claim 1, wherein the penetrating radiation comprises non-ionizing radiation generated from at least one emitter associated with the work machine.

10. A system comprising:
one or more exterior attribute sensors associated with a work machine and configured to generate one or more first input signals corresponding to a field of view of the one or more sensors and comprising one or more plant parts in a work area being traversed by the work machine;
one or more interior attribute sensors associated with the work machine and configured to generate one or more second input signals corresponding to penetrating radiation directed toward the at least one of the one or more plant parts and received by the one or more second sensors; and
one or more processors communicatively linked to the one or more first sensors and to the one or more second sensors to receive the respective input signals there from, and configured to:
identify an exterior attribute of at least one of the one or more plant parts based on the received one or more first input signals;
determine at least one interior plant part attribute with respect to at least one of the one or more plant parts, based on at least the received one or more second input signals; and
generate action signals corresponding to an operation in the work area, based on at least the determined at least one interior plant part attribute.

11. The system of claim 10, wherein at least one of the exterior attribute sensors and at least one of the one or more interior attribute sensors are the same device.

12. The system of claim 10, wherein the one or more interior attribute sensors comprise at least one paired emitter and detector mounted on at least one side of the work machine and configured for reflection and backscatter measurements with respect to the emitted penetrating radiation.

13. The system of claim 10, wherein the one or more interior attribute sensors comprise at least one paired emitter and detector arranged such that plant parts pass between the respective emitter and detector pairing for attenuation measurements with respect to the emitted penetrating radiation.

14. The system of claim 10, wherein the one or more processors are configured to:
train one or more first models over time to correlate identified exterior attributes based on the first input signals with respective types of plant parts; and
train one or more second models over time to correlate characteristics of the penetrating radiation associated with the respective types of plant parts with interior plant part attributes of the respective types of plant parts;
wherein for a current set of one or more first input signals and a corresponding set of one or more second input signals, the at least one interior plant part attribute is determined with respect to the at least one of the one or more plant parts by reference to a selected one of the one or more trained first models to identify a first type of plant part and by reference to a selected one of the one or more trained second models to determine the at least one interior plant part attribute.

15. The system of claim 10, wherein the one or more processors are configured to generate the action signals based on a determined aggregate of interior plant part attributes with respect to a defined period of time and/or with respect to a defined distance traversed by the work machine and/or with respect to the work area being traversed.

16. The system of claim 10, wherein the one or more exterior attribute sensors and the one or more interior attribute sensors are mounted on a first work machine, and the action signals are generated corresponding to the operation by a second work machine in the work area.

17. The system of claim 16, wherein:
the action signals generated by the first work machine are utilized for mapping the determined at least one interior plant part attribute to a location of the respective plant part in a selectively retrievable data structure, for each of the one or more plant parts having an interior plant part attribute determined therefor.

18. The system of claim 17, wherein the operation by the second work machine is controlled based on the mapped attributes in the selectively retrievable data structure.

19. The system of claim 10, wherein the operation is performed in the work area by the work machine, and controlled based on the generated action signals.

20. The system of claim 10, wherein the penetrating radiation comprises non-ionizing radiation generated from at least one emitter associated with the work machine.
